(19) United States
(12) Patent Application Publication
(10) Pub. No.: US 2016/0190670 A1
(43) Pub. Date: Jun. 30, 2016

(54) DIRECT AND COMPACT CHIP TO WAVEGUIDE TRANSITION

(71) Applicant: International Business Machines Corporation, Armonk, NY (US)

(72) Inventors: Roi Carmon, Nesher (IL); Danny Elad, Moshav Liman (IL); Noam Kaminski, Kiryat Tivon (IL); Ofer Markish, Nesher (IL); Thomas Morf, Gross (CH); Evgeny Shumaker, Nesher (IL)

(21) Appl. No.: 15/062,239

(22) Filed: Mar. 7, 2016

Related U.S. Application Data
(63) Continuation of application No. 14/583,715, filed on Dec. 28, 2014.

(51) Int. Cl. H01P 5/08

(52) U.S. Cl. CPC H01P 5/08

(57) ABSTRACT

An apparatus providing a direct chip to waveguide transition, comprising: one or more waveguides, a chip partially embedding each of the waveguides at a transition area positioned at a narrow side of each waveguide, and a transmitting element disposed at each of the transition areas, thereby providing one or more simultaneous, direct transitions between the chip and the waveguides.

### CROSS-REFERENCE TO RELATED APPLICATIONS

This application is a continuation of U.S. patent application Ser. No. 14/583,715, filed Dec. 28, 2014, which is titled “DIRECT AND COMPACT CHIP TO WAVEGUIDE TRANSITION” the application of which is incorporated herein by this reference as though fully set forth herein.

### FIELD OF THE INVENTION

The invention relates to the field of waveguides and integrated circuits.

### BACKGROUND

Typical chip to waveguide transitions require communicating through a transmission line (TL), such as provided on a printed circuit board (PCB), that result in lossy connections between the chip, TL, and PCB. Although flipchip configurations providing transmission capability through one or more solder bumps can reduce signal loss somewhat, as operating frequencies increase above 150 GHz, the approach becomes inefficient as well.

The following table illustrates typical losses of some known chip to waveguide communications systems operating around 100 GHz in a flipchip configuration:

| | | | Total |
|---|---|---|---|
| Chip to PCB | 8 mm PCB TL | PCB to WG | average |
| average | average | average | In-band |
| In-band losses | In-band losses | In-band losses | losses |
| 0.7 dB | 1.8 dB | 0.5 dB | 3 dB |

Additionally, current solutions for chip to waveguide transitions occupy a significant amount of chip and PCB real estate.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, an apparatus providing a direct chip to waveguide transition, comprising: one or more waveguides; a chip partially embedding each of said waveguides at a transition area positioned at a narrow side of each waveguide, and a transmitting element disposed at each of said transition areas, thereby providing one or more simultaneous, direct transitions between said chip and said one or more waveguides.

In some embodiments, a thinned periphery of said chip comprises at least a portion of each of said transition areas.

In some embodiments, a thickness of said thinned periphery of said chip is in an order of 200 microns.

In some embodiments, said transmitting element comprises a ring antenna that is disposed at said thinned periphery of said chip.

In some embodiments, said transmitting element comprises a tapered slot passage providing wideband signal transmission capability.

In some embodiments, said transition area further comprises a substrate layer that is electrically connected to said thinned periphery of said chip, and galvanically connected to said waveguide.

In some embodiments, said tapered slot passage comprises a first portion disposed at said thinned periphery of said chip, and a second portion disposed at said substrate layer.

In some embodiments, a size of said chip is in an order of 6 mm×6 mm.

In some embodiments, a combined size of said chip and said substrate layer is 16 mm×16 mm.

In some embodiments, said chip is configured to operate at frequencies in the order of 100 GHz.

In some embodiments, said narrow side of said waveguide is 0.8 mm.

In some embodiments, the direct chip to waveguide transition of claim 1 further comprises a balun configured to balance a signal between said transmitting element and a drive circuit of said chip.

In some embodiments, the direct chip to waveguide transition of claim 1 further comprises a tuning element configured with said transmitting element to adjust a frequency response of said transmitting element to suit a signal transmitted via said waveguide.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a simplified conceptual illustration of a cross-sectional view of a direct chip to waveguide transition, in accordance with an embodiment of the invention;

FIG. 2A is a simplified conceptual illustration of cross-sectional view of a direct chip to waveguide transition, in accordance with another embodiment of the invention;

FIG. 2B is a simplified conceptual illustration of a top view of the direct chip to waveguide transition of the invention of FIG. 2A;

FIG. 3A is a simplified conceptual illustration of a regular slot antenna configured for narrow bandwidth operation, operative in accordance with an embodiment of the invention;

FIG. 3B is a simplified conceptual illustration of a tapered slot antenna configured for wide bandwidth operation and improved signal matching, operative in accordance with an embodiment of the invention;

FIG. 3C shows a simplified conceptual illustration of a cross-sectional view of a direct chip to waveguide transition, in accordance with another embodiment of the invention;

FIG. 3D is a simplified conceptual illustration of a top view of the direct chip to waveguide transition of the invention of FIG. 3C; and

FIG. 4 illustrates the results of a performance simulation of a direct chip to waveguide transition, in accordance with an embodiment of the invention.

### DETAILED DESCRIPTION

A solution is presented for providing direct chip to waveguide signal transmission and reception for the millimeter-wave domain, and that is compatible with standard semiconductor technologies, such as Silicon complementary metal-oxide-semiconductor (Si CMOS), and silicon-germanium bipolar CMOS (SiGe BiCMOS). The presented solution reduces loss and provides for smaller system packaging. A chip is provided with multiple direct transitions to multiple waveguides, allowing for simultaneous transmission and reception of high quality, low loss signal to and from multiple waveguides while occupying a smaller region on a PCB, substrate or other such platform.

In one embodiment, an edge of the chip that is coupled with the waveguide may be thinned using an etching process, thereby reducing signal loss.

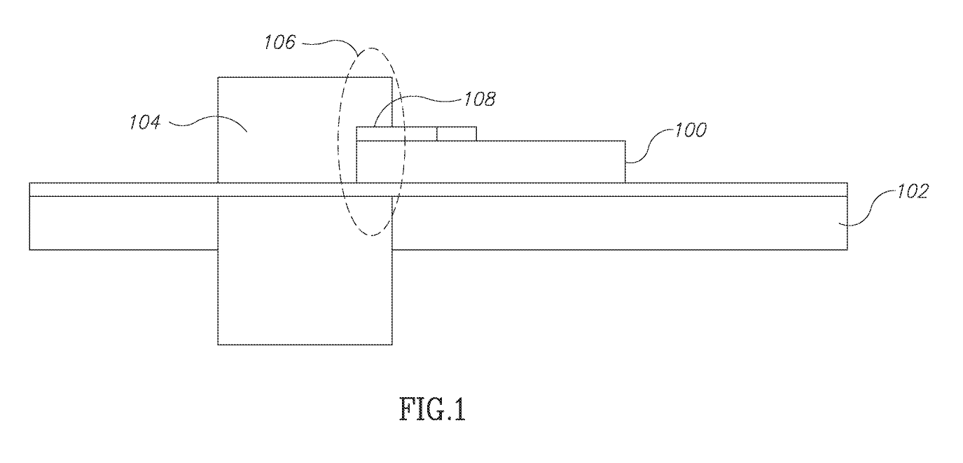

Reference is made to FIG. 1 which shows a simplified conceptual illustration of a cross-sectional view of a direct chip to waveguide transition, in accordance with an embodiment of the invention. For clarification purposes, FIG. 1 illustrates a single chip to waveguide transition. However, the invention disclosed herein equally applies to multiple transitions to multiple waveguides from a single chip.

A semiconductor chip 100 may be mounted on a substrate 102 to partially embed one or more waveguides 104 at one or more transition areas 106 positioned at a narrow side of each of said waveguides. A transmitting element 108 may be disposed at each of transition areas 106 to provide multiple simultaneous, direct transitions between chip 100 and one or more waveguides 104. Thus, chip 100 may directly transmit and receive multiple signals from multiple waveguides 106 simultaneously via multiple transmitting devices 108.

In an embodiment, at least a portion of transition area 106 may comprise a periphery of chip 100 that may be thinned in the order of 200 microns.

In an embodiment, the width of the narrow side of waveguide 104 may be approximately 0.8 mm, which is about 40% smaller than the width of standards waveguides. The bottom and upper backshorts of waveguide 104 may be metallic plated cavities, alternatively they may be made of multilayer substrate with peripheral vias.

In an embodiment, chip 100 has not contact with a backshort of waveguide 104.

In an embodiment, chip 100 is directly embedded within waveguide 104 without a plastic moulding encapsulating chip 100.

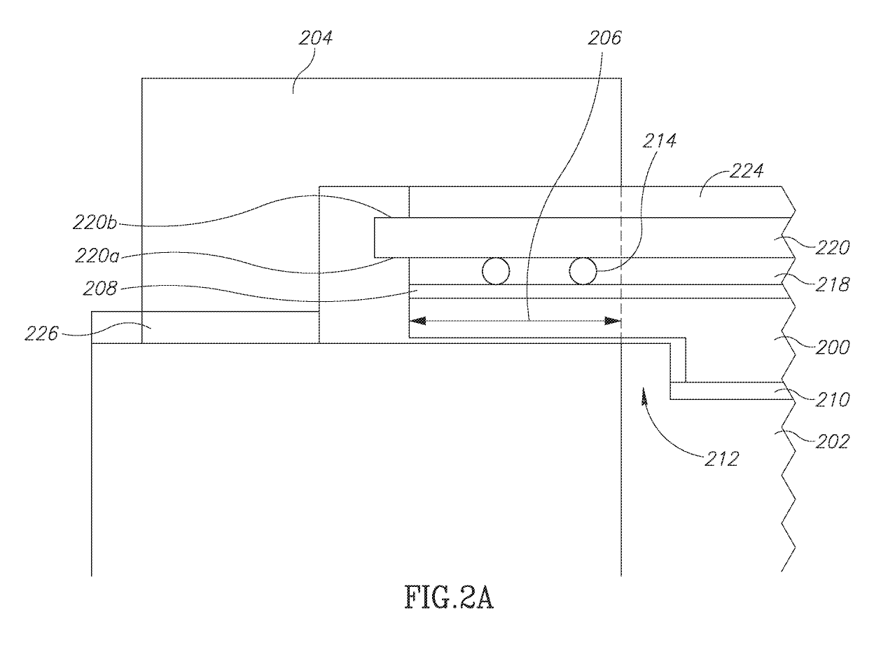

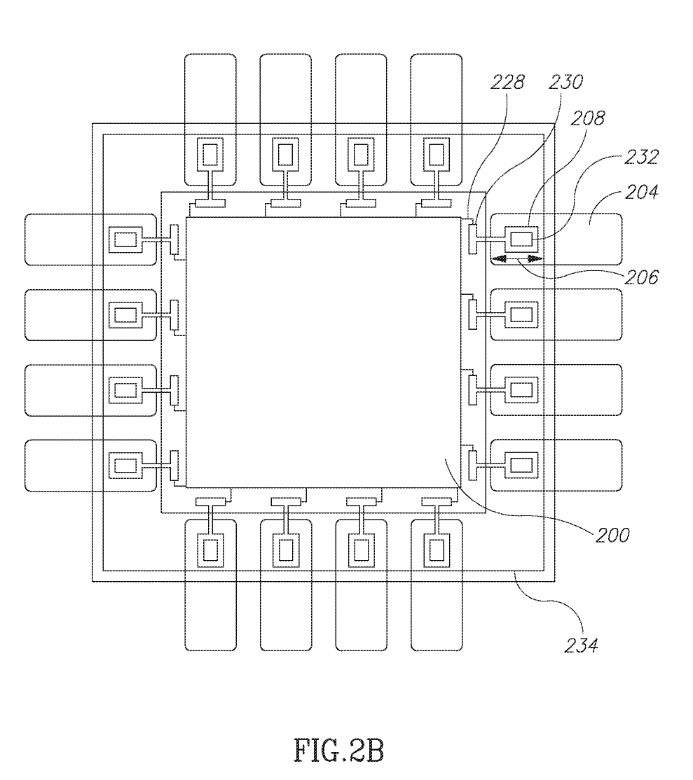

Reference is now made to FIG. 2A which is a simplified conceptual illustration of a cross-sectional view of a direct chip to waveguide transition, in accordance with another embodiment of the invention. A chip 200 may be mounted on a substrate 202, such as with a thermal gel layer 210 at a platform 212 etched on substrate 202. A transition area 206, comprising a thinned periphery of chip 200, may be embedded within a waveguide 204. Chip 200 may be standard mounted on substrate 202, or alternatively, chip 200 may have a ‘flip-chip’ architecture.

In an embodiment, the width of the surface of the thinned periphery of chip 200 does not exceed 1 mm. A transmitting device 208 may be disposed at transition area 206, thereby embedding transition device 208 within waveguide 204. Transition device 208 may comprise an antenna for converting an electric signal to an electromagnetic signal for transmitting in waveguide 204.

Chip 200 may be electrically connected to waveguide 204 via a substrate layer 220 that may be fastened to waveguide 204 with a conducting glue layer 224. One or more conductive chip bumps 214 may be positioned within an underfill 218 connecting transmitting device 208 on chip 200 to a substrate metal bottom 220a and substrate metal top 220b, thereby providing electrical conductivity between transmitting device 208 and waveguide 204, allowing transmitting device 208 to radiate freely in the inner volume of waveguide 204. A shim 226 may be provided with waveguide 204 to provide mechanical strength and support. In an embodiment, waveguide 204 may be narrower at a portion situated above shim 226, and may be wider at a portion situated below shim 226, as shown in FIG. 2A. Alternatively, waveguide 204 may be of uniform width above and below shim 226.

Reference is now made to FIG. 2B which shows a simplified top view of the direct chip to waveguide transition in accordance with an embodiment of the invention. Chip 200 may directly embed one or more waveguides 204 at one or more transition areas 206 comprising a thinned periphery of chip 200. Each of transition areas 206 may be disposed with a transmitting element 208, such as a differential ring antenna that may be configured to radiate autonomously into waveguide 204, thereby simultaneously embedding multiple transmitting elements 208 within multiple waveguides 204 and providing multiple, simultaneous direct chip to waveguide transitions in a compact manner with low signal loss.

For the purpose of simplicity, the following description of FIG. 2B will refer to a single direct chip to waveguide transmission. However, it is to be understood that the description equally applies to simultaneous direct single chip to multiple waveguide transmissions.

In an embodiment, waveguide 204 may have a rectangular, or oblong shaped cross-section for providing a narrow side of waveguide 204 for coupling to chip 200 via transition area 206, thereby allowing for a compact design to embed a relatively small portion of chip 200 within each waveguide 204. In this manner, multiple waveguides 204 may be coupled to a single chip 200. In some embodiments, the narrow side of the waveguide may range from 0.8 mm to 1.27 mm.

In an embodiment, a balun 230 coupled to a port 228 may be provided to balance an impedance load between a drive circuit of chip 200 and transmitting device 208, thereby increasing efficiency of signal transmission by reducing reflective loss.

Transmitting device 208 may comprise a differential ring antenna that may receive an electric signal from chip 200 via port 228 and balun 230, and convert the signal to an electromagnetic signal which is radiated directly into waveguide 204 at transition area 206. A tuning element 232 may be provided with antenna 208 to adjust a frequency response of antenna 208 to suit a signal transmitted via waveguide 204.

Similarly, antenna 208 may directly receive a radiated electromagnetic signal from waveguide 204 and convert it to an electric current for directly transmitting to chip 200. Antenna 208 may transmit the electric signal through balun 230 where it may be load balanced to the circuitry of chip 200. Chip 200 may receive the balanced electric signal at port 228 via metal top and bottom 220a and 220b and optionally bumps 214, shown in FIG. 2A. A chip ring 234 may be provided with chip 200.

In an embodiment, a signal may be fed to antenna 208 via ports 208a and 208b that are oriented at 180 degrees from each other, thereby providing a differential nature to the antenna allowing robust transition to waveguide 204, as well as wideband transmission capability to antenna 208. In an embodiment, a single lead from chip 200 may be translated by balun 230 to two parallel leads that both are fed to antenna 208, providing antenna 208 with a differential signal that is orientated at 180 degrees. Alternatively, chip 200 may directly provide antenna 208 with a differential feed.

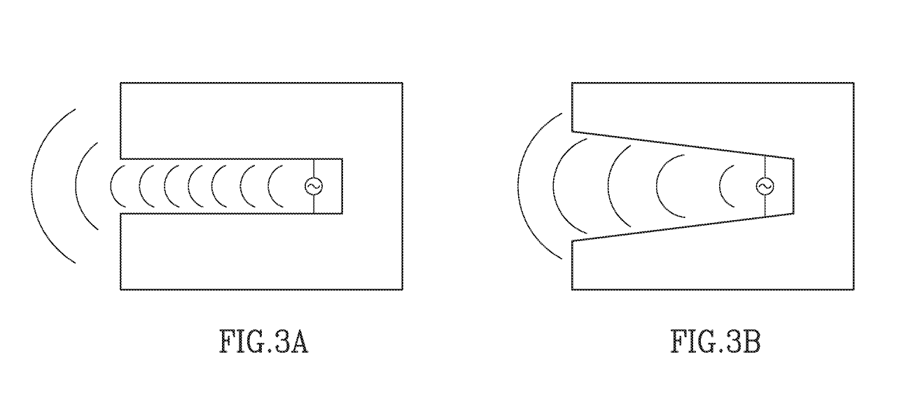

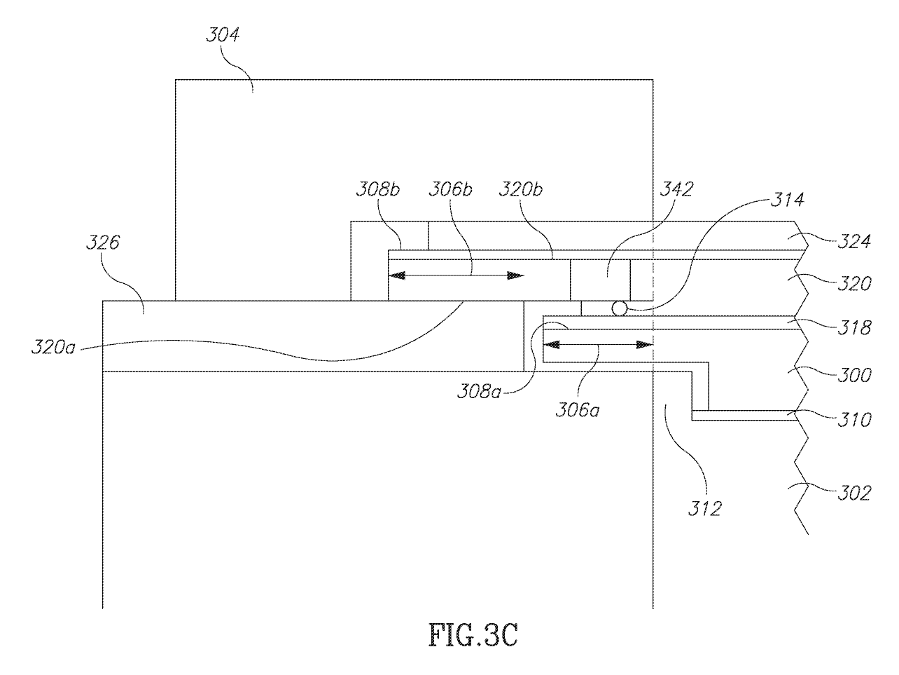

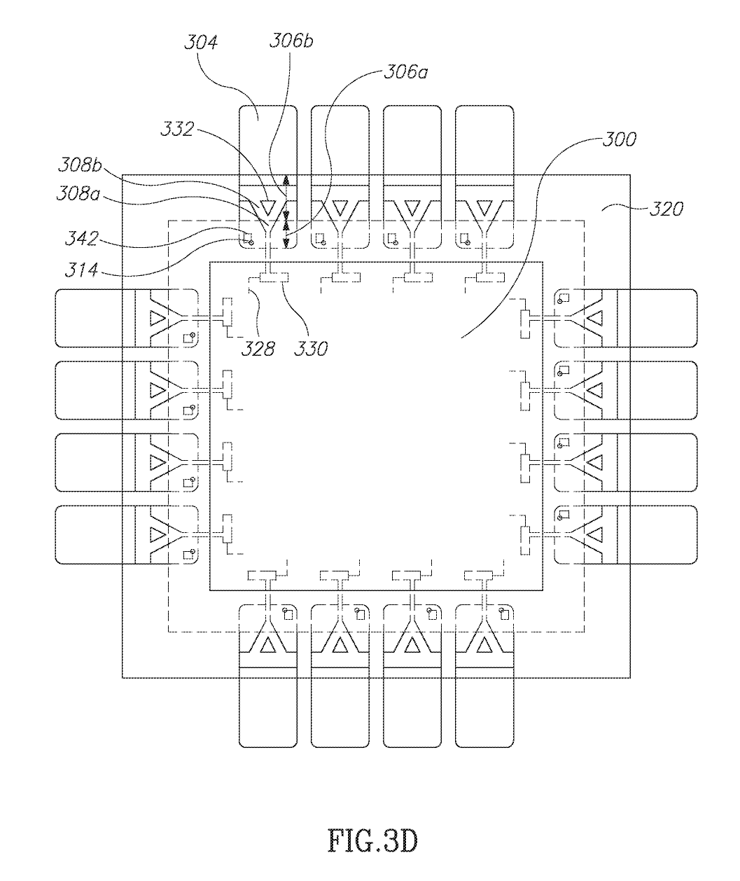

Reference is now made to FIGS. 3A-B which illustrate two tapered slot passage elements for converting an electric signal to an electromagnetic signal, operative in accordance with an embodiment of the invention. The antenna illustrated in FIG. 3A comprises a regular slot passage for radiating a signal within a narrow-band transmission capability. By contrast, the geometry of a tapered slot passage illustrated in FIG. 3B may guide the waves of the converted electromagnetic signal from a small excitation area to a large aperture for efficient radiation over a range of frequencies in a waveguide, thereby providing wideband transmission capability.

Reference is now made to FIGS. 3C-D, which taken together, are a simplified conceptual illustration of another direct chip to waveguide transition, in accordance with an embodiment of the invention. A chip 300 may be mounted on a substrate 302, such as with a thermal gel layer 310 at a platform 312 etched on substrate 302. Chip 300 may be standard mounted on substrate 302, or alternatively, chip 300 may have a ‘flip-chip’ architecture and may be mounted on substrate 302 with one or more chip bumps 314, such as conductive solder bumps, that are optionally positioned within an underfill 318.

Chip 300 may directly embed one or more waveguides 304 at one or more transition areas comprising transition area pairs 306a and 306b. Transition area 306a may comprise a thinned periphery of chip 300, and transition area 306b may comprise a portion of a substrate layer 320 that is galvanically and electrically connected to waveguide 304 via a conductive metal top 320b and a conductive glue layer 324. Substrate layer 320 may be adjacent to and electrically connected to the thinned periphery of chip 300 via a conductive metal bottom 320a, bumps 314 and vias 342, thereby electrically connecting transition area pairs 306a and 306b to each other. In an embodiment, substrate layer 320 may be composed of alumina, aluminum nitride or any other ceramic or organic laminate.

Transitions area pairs 306a and 306b may together be provided with a transmitting element, such as a differential tapered slot passage providing wideband capability described in FIG. 3B, and comprising a chip transmitting portion 308a and a substrate transmitting portion 308b, as follows: chip transmitting portion 308a may be disposed at transition area 306a at the etched periphery of chip 300, and substrate transmitting portion 308b may be disposed at substrate layer 320, thereby galvanically connecting substrate transmitting portion 308b to waveguide 304. Transmitting element portions 308a and 308b may be electrically connected to the top and bottom portions of waveguide 304 and may together be configured to directly transmit a signal between chip 300 and waveguide 304, thereby providing wideband signal transmission between chip 300 and waveguide 304.

An electric signal received by transmitting element 308a from chip 300 may flow through bumps 314 to substrate metal bottom 320a, through via 342 to substrate metal top 320b to transmitting element 308b. Transmitting element 308b may convert the electric signal to an electromagnetic signal for transmission via waveguide 304.

A shim 326 may be provided with waveguide 304 to provide mechanical strength and support.

Reference is now made to FIG. 3D which shows a simplified top view of the direct chip to waveguide transition in accordance with an embodiment of the invention. Chip 300 may be directly connected to one or more waveguides 304 at transition area pairs 306a and 306b, thereby enabling multiple simultaneous compact and low loss transitions to multiple waveguides.

Each of transition area pairs 306a and 306b may be disposed with a transmitting element comprising pairs 308a and 308b, as described above, thereby simultaneously embedding multiple transmitting element pairs 308a and 308b within multiple waveguides 304 for providing multiple, simultaneous, wideband direct chip to waveguide communications.

For the purpose of simplicity, the following description of FIG. 3D will refer to a single direct chip to waveguide transmission. However, it is to be understood that the description equally applies to multiple simultaneous direct chip to waveguide transmissions.

Reference is now made to FIG. 3D which shows a simplified top view of the direct chip to waveguide transition of FIG. 3C. In an embodiment, waveguide 304 may have a rectangular, or oblong shaped cross-section for providing a narrow side of waveguide 304 for coupling to chip 300 via transition areas 306a and 306b, thereby allowing for a compact design to embed a relatively small portion of chip 300 within each waveguide 304. In this manner, multiple waveguides 304 may be coupled to a single chip 300. In some embodiments, the narrow side of the waveguide ranges from 0.8 mm to 1.27 mm.

Transmitting element pair 308a and 308b may together comprise a tapered slot passage transmitting element, enabling wideband operation, such as shown in FIG. 3A for converting an electrical signal originating from chip 300 to an electromagnetic signal for transmission via waveguide 304. Transmitting element 308a may comprise an on-chip tapered slot portion disposed at transition area 306a comprising the etched periphery of chip 300. Transmitting element 308b may comprise a substrate tapered slot portion disposed with substrate transition area 306b at substrate layer 320, where substrate tapered slot portion 308b may be galvanically connected to waveguide 304, thereby improving performance.

A tuning element 332 may be provided with tapered slot portion 308b to adjust the frequency response to suit a signal transmitted via waveguide 304.

In an embodiment, a balun 330 coupled to a port 328 may be provided to balance an impedance load between a drive circuit of chip 300 and transmitting elements 308a and 308b, thereby increasing efficiency of signal transmission by reducing reflective loss.

On-chip tapered slot portion 308a may receive an electric signal from chip 300 via balun 330 and port 228, and convey the signal to substrate tapered slot portion 308b via bumps 314, vias 342, metal bottom 320a, and metal top 320b, shown in FIG. 3C. Substrate tapered slot portion 308b may convert the signal to an electromagnetic signal, which may be optionally tuned by tuning element 332 and radiated directly into waveguide 304.

Similarly, substrate tapered slot portion 308b may directly receive at transition area 306b a radiated electromagnetic signal from waveguide 304 and convert it to an electric current for transmitting to chip 300. The signal may be conveyed via bumps 314, vias 340, metal bottom 320a, and metal top 320b to on-chip substrate tapered slot portion 308a disposed at transition area 306a, where it may flow through balun 330 for load balancing to the circuitry of chip 300.

In an embodiment, the combined size of chip 300 and substrate layer 320 may be approximately 16 mm×16 mm for operation at frequencies of approximately 100 GHz. In an embodiment the size of chip 300 without substrate layer 320 may be in the order of 6 mm×6 mm, and the width of etched portion of chip 300 providing transition area 306a may be in the order of 1 mm or less. Chip 300 and substrate layer 320 may be scaled accordingly for higher frequencies.

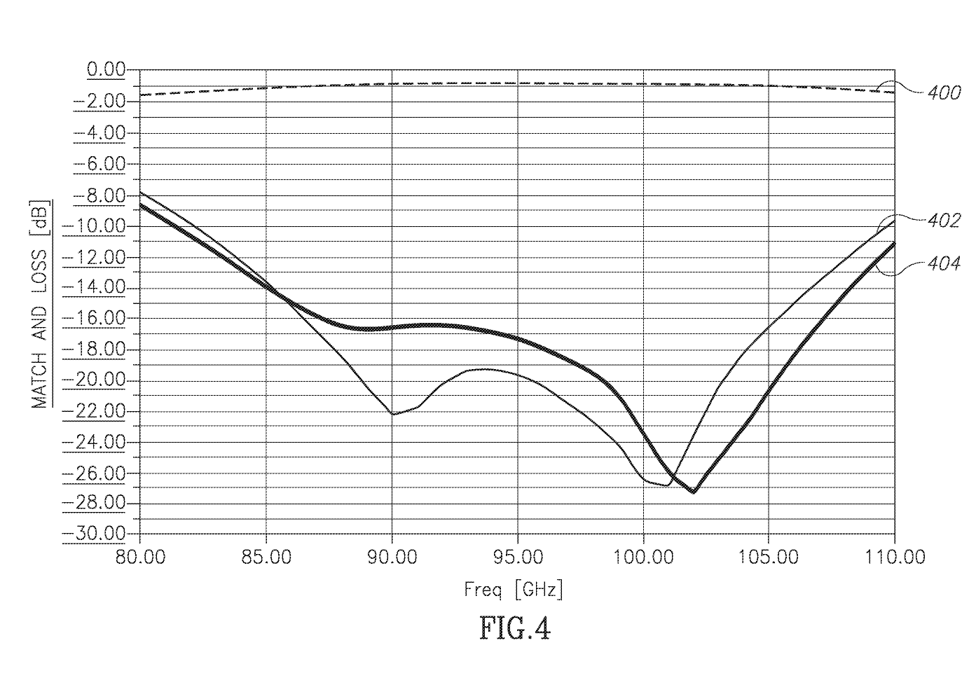

In this manner, a single chip may communicate simultaneously with multiple waveguides, providing compact size wafer level processing, and low signal loss. Reference is now made to FIG. 4, which illustrates the results of a performance simulation of a direct chip to waveguide transition, in accordance with an embodiment of the invention. Curve 400 illustrates simulated signal loss vs. frequency performance results for multiple chip to waveguide transitions, in accordance with the system of FIGS. 3C-D. It may be noted that without the inclusion of balun 330, the performance may be expected to improve by approximately 0.5 dB. By contrast, curves 402 and 404 illustrate simulated signal return loss vs. frequency performances for prior art systems operating in wide-band frequencies.

Thus, the system disclosed herein provides improved performance for a single chip to waveguide transition, and additionally provides a single chip with multiple simultaneous direct chip to waveguide transition.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

What is claimed is:

1. An apparatus providing a direct chip to waveguide transition, comprising:
one or more waveguides;
a chip partially embedding each of said waveguides at a transition area positioned at a narrow side of each waveguide, and
a transmitting element comprising an antenna disposed at each of said transition areas, thereby providing one or more simultaneous, direct transitions between said chip and said one or more waveguides.

2. The apparatus of claim 1, wherein a thinned periphery of said chip comprises at least a portion of each of said transition areas.

3. The apparatus of claim 2, wherein a thickness of said thinned periphery of said chip is in an order of 200 microns.

4. The apparatus of claim 2, wherein said antenna is a ring antenna that is disposed at said thinned periphery of said chip.

5. The apparatus of claim 2, wherein said transmitting element comprises a tapered slot passage providing wideband signal transmission capability.

6. The apparatus of claim 5, wherein said transition area further comprises a substrate layer that is electrically connected to said thinned periphery of said chip, and galvanically connected to said waveguide.

7. The apparatus of claim 6, wherein said tapered slot passage comprises a first portion disposed at said thinned periphery of said chip, and a second portion disposed at said substrate layer.

8. The apparatus of claim 7, wherein a size of said chip is in an order of 6 mm×6 mm.

9. The apparatus of claim 7, wherein a combined size of said chip and said substrate layer is 16 mm×16 mm.

10. The apparatus of claim 7, wherein said chip is configured to operate at frequencies in the order of 100 GHz.

11. The apparatus of claim 1, wherein said narrow side of said waveguide is 0.8 mm.

12. The apparatus of claim 1, further comprising a balun configured to balance a signal between said transmitting element and a drive circuit of said chip.

13. The apparatus of claim 1, further comprising a tuning element configured with said transmitting element to adjust a frequency response of said transmitting element to suit a signal transmitted via said waveguide.
